(19) United States
(12) Patent Application Publication
(10) Pub. No.: US 2018/0156176 A1
(43) Pub. Date: Jun. 7, 2018

(54) HIGH PRESSURE VALVE

(71) Applicant: Delphi International Operations Luxembourg, S.A.R.L., Bascharage (LU)

(72) Inventors: Onur Tansug, Izmir (TR); Sencer Kiris, Izmir (TR)

(21) Appl. No.: 15/577,000

(22) PCT Filed: Mar. 18, 2016
(86) PCT No.: PCT/EP2016/056073

§ 371 Date: Nov. 27, 2017

(30) Foreign Application Priority Data
May 29, 2015 (GB) 1509225.7

(51) Int. Cl. F02M 63/02; F02M 63/00

(52) U.S. Cl. CPC F02M 63/025; F02M 63/0052; F02M 63/0017

(57) ABSTRACT

A cap assembly adapted to be fixed on the body member of a pressure regulating valve defines an internal cylindrical volume for enclosing a magnetic plunger member. The cap assembly includes a cylindrical magnetic cap member in which is totally inserted a non-magnetic cylindrical tube member, the tube member being adapted to be fixed on the valve body member.

### CROSS REFERENCE TO RELATED APPLICATIONS

This application is a national stage application under 35 USC 371 of PCT Application No. PCT/EP2016/056073 having an international filing date of Mar. 18, 2016, which is designated in the United States and which claimed the benefit of GB Patent Application No. 1509225.7 filed on May 29, 2015, the entire disclosures of each are hereby incorporated by reference in their entirety.

### TECHNICAL FIELD

The present invention relates generally to a high pressure valve adapted to be arranged in fuel injection equipment and, more particularly to its cap assembly enclosing a plunger member.

### BACKGROUND OF THE INVENTION

In fuel injection equipment, a high pressure valve is arranged in order to control the pressure inside a common rail reservoir.

An external electronic command unit is connected to a solenoid which, when energized generates a magnetic field attracting a magnetic plunger that forces a needle valve member to close a spill orifice forbidding fuel release and pressure drop.

The valve member comprises a solenoid that generates a magnetic field attracting a plunger, said plunger cooperating with the valve needle. The plunger is enclosed at an extremity of the body of the valve, within a magnetic cap assembly, magnetically isolated from the plunger and from the body. The cap assembly comprises a magnetic cap member and a non-magnetic tube member welded to each other. In time, cracks have occurred and propagated in the welding seam between the cap member and the tube member weakening the assembly.

### SUMMARY OF THE INVENTION

It is an object of the invention to resolve or at least mitigate the above mentioned problem by proposing a cap assembly adapted to be fixed on the body member of a pressure regulating valve regulating the pressure inside the common rail reservoir of fuel injection equipment. The cap assembly and the valve body member define an internal cylindrical volume for enclosing a magnetic plunger member, the cap assembly comprising fixedly arranged together a magnetic cap member and a non-magnetic tube member. The magnetic cap member has a disc face limited by a circular board from which perpendicularly erects a cylindrical peripheral wall extending along a longitudinal axis toward a distal circular edge and, the non-magnetic cylindrical tube member axially extends between a first edge arranged inside the cap member, and a second edge. The tube member is adapted to be fixed on the valve body member in order to magnetically isolate the cap member from said valve body member.

Advantageously, the tube member is inserted inside the peripheral wall of the cap member so that the second edge of the tube member is flush with the circular edge of the cap member, optimizing the magnetic force generated by the solenoid.

Also, the internal face of the cap member comprises a wider diameter in the distal end portion of the peripheral wall, said wider portion and the bottom portion of the internal face merging in an internal shoulder face, the tube member being totally inserted in said wider portion, so that the internal cylindrical face of the tube member is in surface continuity with the internal face of the bottom portion of the peripheral wall of the cap member.

Also, the first edge of the tube member comes close against the internal shoulder face.

The invention further extends to a body assembly of a pressure regulating valve adapted to regulate the pressure inside the common rail reservoir of fuel injection equipment. The body assembly comprises a body member on which is fixed a magnetic plunger assembly. The body member has a substantially cylindrical form made of a plurality of coaxial cylindrical portions extending along the longitudinal axis between the first transverse face, adapted to be fixed in the rail and, the distal second transverse face, adapted to receive the plunger assembly; the body member being further provided with an axial through bore opening in both transverse faces and adapted to receive a needle valve member slidably arranged to translate between an open position and a closed position.

The magnetic plunger assembly comprises a magnetic plunger member and a cap assembly as described above, the plunger member being adapted to axially translate under the influence of a magnetic field within said internal cylindrical volume defined by the cap assembly and the valve body member.

Also, the cap assembly is fixedly arranged on the body member, the internal face of the tube member being adjusted onto the external face of the cylindrical portion of the body member that is adjacent to said second transverse face.

Also, the tube member is only partially arranged onto the body member, a portion of the tube member axially extending beyond the second transverse face of the body member.

Also, the cylindrical portion adjacent to the second transverse face of the body member merges into an external shoulder face against which is the second edge of the tube member.

Also, the magnetic plunger assembly is welded onto the body member via a non-magnetic welding seam joining the body member to the cap assembly.

Also, the non-magnetic welding seam is arranged between the distal circular edge of the cap member and the external shoulder face of the body member.

The invention further extends to a pressure regulating valve adapted to regulate the pressure inside the common rail reservoir of fuel injection equipment, the valve having body assembly as described above.

Also, the pressure regulating valve further comprises a solenoid assembly arranged over the cap assembly, said actuator generating the magnetic field when electrically energized.

### BRIEF DESCRIPTION OF THE DRAWINGS

The present invention is now described by way of example with reference to the accompanying drawings in which:

FIG. 1 is a general representation of fuel injection equipment.

FIG. 2 is an axial section of a high pressure valve as per the invention.

FIG. 3 is an axial section of the body of the valve of FIG. 2.

FIG. 4 is an axial section of the cap assembly represented on the valve of FIG. 2.

### DESCRIPTION OF THE PREFERRED EMBODIMENTS

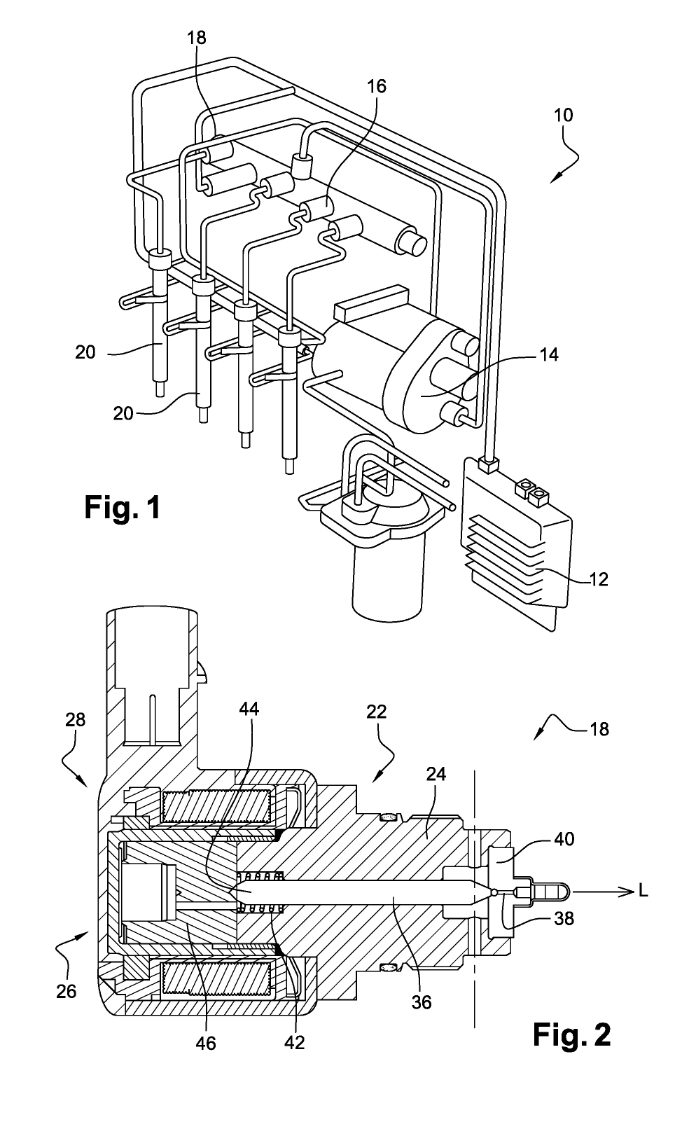

In FIG. 1 is represented fuel injection equipment (FIE) 10 controlled by an electronic control unit (ECU) 12. The FIE 10 comprises a high pressure pump 14 that pressurises fuel flowed into a high pressure reservoir 16, known as a common rail in reference to its elongated shape. On the rail 16 are arranged in fluid connection a pressure regulating valve 18 and several fuel injectors 20, four being represented on the figure, adapted to spray fuel in combustion chambers of an internal combustion engine.

From the pressure regulating valve 18 depart a return fluid circuit flowing fuel at low pressure back to a low pressure reservoir. The ECU 12 controls the operation of the high pressure pump 14, the pressure valve 18 and the injectors 20 as a function of the pressure of the fuel desired to be sprayed in the engine.

The pressure regulating valve 18, now described in reference to FIG. 2, is arranged at an extremity of the rail 16 wherefrom it extends along a longitudinal axis L. It is an electro-magnetic valve comprising mainly a body assembly 22, comprising a body member 24 on which is fixed a plunger assembly 26, and a solenoid assembly 28.

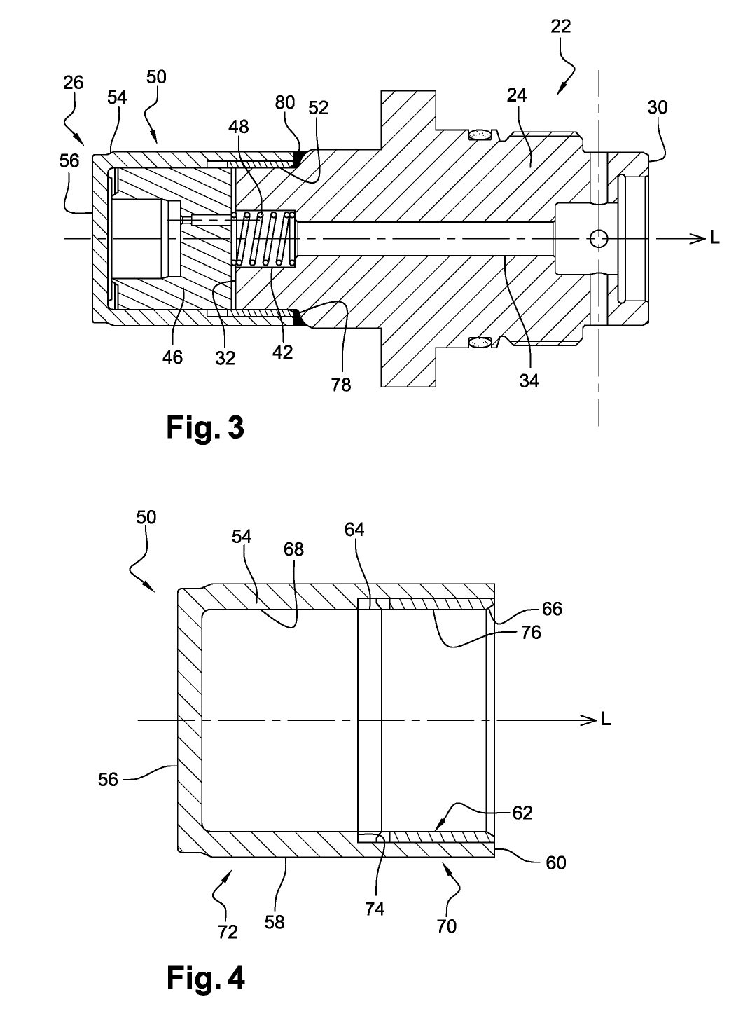

The body assembly 22, detailed on FIG. 3, comprises the body member 24 which has a substantially cylindrical form made of a plurality of coaxial L cylindrical portions, the body member 24 extending between a first transverse face 30, adapted to be fixed on the rail 16, and a distal second transverse face 32, adapted to receive the plunger assembly 26. The body member 24 is further provided with an axial L through bore 34 opening in both transverse faces 30, 32, and in which is slidably arranged a needle valve member 36 adapted to translate between a closed position CP, where the tip end of the needle 36 closes a spill orifice 38 extending through a seat member 40 and, an open position OP where the tip of the needle 36 is lifted away from the seat member 40, opening the spill orifice 38 and enabling fuel to exit the rail 16 and to flow back toward a low pressure reservoir or drain. The second transverse face 32 is provided with a central recess 42 at the bottom of which opens the bore 34, the head of the needle 36 protruding in the recess 42, the extremity 44 of the head being flush with the second transverse face 32. A spring 48 is arranged in the recess 42, around the head of the needle 36, and is compressed between the bottom of the recess 42 and a plunger member 46.

The magnetic plunger assembly 26 comprises a fixed cap assembly 50, detailed on FIG. 4, arranged on the last cylindrical portion 52 of the body member 24, the cap assembly 50 and the body member 24 defining together an internal cylindrical volume V enclosing the magnetic plunger member 46 where I is adapted to axially L translate under the influence of a magnetic field M generated by the solenoid 28 when electrically energized.

The cap assembly 50 has a cylindrical shape and it comprises the fixed assembly of a magnetic cap member 54 having a transverse disc face 56 from the circular board of which perpendicularly erects a cylindrical peripheral wall 58 extending along the longitudinal axis L toward a distal circular edge 60 and, a non-magnetic cylindrical tube 62 axially L extending between a first edge 64 arranged inside the cap member 54, and a second edge 66 flush with the circular edge 60 of the cap member 54.

The internal face 68 of the cap member 54 comprises a wider diameter in the distal end portion 70 of the peripheral wall, said wider portion 70 and the bottom portion 72 of the internal face 68 merging in an internal shoulder face 74. The tube member 62 is inserted, with press fit or slight fit or simply adjusted, in said wider portion 70 so that the internal cylindrical face 76 of the tube member 62 is in surface continuity with the internal face 68 of the bottom portion 72 of the peripheral wall 58. As it is visible on the figures, the first edge 64 of the tube comes close to the shoulder face 74 and as said above, the second edge 66 of the tube is flush with the circular edge 60 of the cap member 54.

Also, the magnetic plunger assembly 26 is arranged on the body member 24, the plunger member 46 being placed in said volume V, the spring 48 being compressed so that it permanently solicits the plunger member 26 away from the second transverse face 32 of the body member 24. The tube member 62 is partially press-fitted, or slight fitted or simply adjusted, onto the last cylindrical portion 52 of the body member 24, so that, the second edge 66 of the tube member 62 is against an external shoulder face 78 arranged at the end of the last cylindrical portion 52 of the body member 24. The portion of the tube member 62 that is in the vicinity of the first edge 64 axially extends beyond the second transverse face 32 of the body.

The plunger assembly 26 is finally fixed onto the body member 24 by welding the cap assembly 50 on said body member 24 with a non-magnetic welding seam 80 joining the circular edge 60 of the cap member, the second edge 66 of the tube member and the external shoulder face 78 of the body member 24.

The solenoid assembly 28, comprising both a solenoid and an electric connector enabling electrical energizing the solenoid, is arranged over the cap assembly 50 so that, when the solenoid is not energized, the spring 48 pushes the plunger member 46 away from the second face 32 of the body member, the fuel pressure in the rail 16 generating on the needle member 36, through the spill orifice 38, an opening force lifting the needle 36 in open position OP and, when the solenoid is energized it generates the magnetic field M attracting the plunger member 46 toward the second transverse face 32, compressing the spring 48, and pushing the needle member 36 in closed position CP.

When the solenoid is energized, the magnetic field M loops around the solenoid going through the cap member, through the plunger member 46, through the body member 24 via the second transverse face 32, then through the armature of the solenoid that externally surrounds the solenoid.

### LIST OF REFERENCES

L longitudinal axis

CP closed position

OP open position

V volume

M magnetic field

10 fuel injection equipment

12 electronic control unit

14 pressure regulating pump

16 common rail

18 pressure regulating valve

20 injector

22 valve body assembly

24 body member

26 magnetic plunger assembly

28 solenoid assembly

30 first transverse face

32 second transverse face

34 bore

36 needle valve member

38 spill orifice

40 seat member

42 recess

44 extremity of the head of the needle

46 plunger member

48 spring

50 cap assembly

52 last cylindrical portion of the body member

54 magnetic cap member

56 transverse disc face

58 peripheral wall

60 circular edge

62 non-magnetic cylindrical tube member

64 first edge of the tube

66 second edge of the tube

68 internal face of the peripheral wall

70 wider portion of the peripheral wall

72 bottom portion of the peripheral wall

74 internal shoulder face

76 internal cylindrical face of the tube

78 external shoulder face

80 non-magnetic welding seam

1-11. (canceled)

12. A cap assembly adapted to be fixed on a body member of a pressure regulating valve which regulates the pressure inside a common rail reservoir of fuel injection equipment, the cap assembly and the body member defining an internal cylindrical volume for enclosing a magnetic plunger member, the cap assembly comprising:
a magnetic cap member having a disc face limited by a circular board from which perpendicularly extends a cylindrical peripheral wall extending along a longitudinal axis toward a distal circular edge; and
a non-magnetic tube member fixed to the magnetic cap member, the non-magnetic tube member axially extending between a first edge arranged inside the magnetic cap member, and a second edge, the non-magnetic tube member being adapted to be fixed on the body member in order to magnetically isolate the magnetic cap member from the body member, the non-magnetic tube member being located inside the cylindrical peripheral wall of the magnetic cap member so that the second edge of the non-magnetic tube member is flush with the distal circular edge of the magnetic cap member.

13. A cap assembly as claimed in claim 12 wherein the cylindrical peripheral wall of the magnetic cap member defines an internal face which comprises a wider diameter in a distal end portion of the peripheral wall, the wider diameter and a bottom portion of the internal face merging in an internal shoulder face, the non-magnetic tube member being totally inserted in the wider diameter, so that an internal cylindrical face of the non-magnetic tube member is in surface continuity with the internal face of the bottom portion of the cylindrical peripheral wall of the magnetic cap member.

14. A cap assembly as claimed in claim 13 wherein the first edge of the non-magnetic tube member comes close against the internal shoulder face.

15. A body assembly of a pressure regulating valve adapted to regulate pressure inside a common rail reservoir of fuel injection equipment, the body assembly comprising a body member on which is fixed a magnetic plunger assembly;
the body member having a substantially cylindrical form made of a plurality of coaxial cylindrical portions extending along a longitudinal axis between a first transverse face, adapted to be fixed in the common rail reservoir and, a distal second transverse face, adapted to receive the magnetic plunger assembly; the body member being further provided with an axial through bore opening in both the first transverse face and the distal second transverse face and adapted to receive a needle valve member slidably arranged to translate between an open position and a closed position and;
the magnetic plunger assembly comprising a magnetic plunger member and a cap assembly, the cap assembly comprising:
a magnetic cap member having a disc face limited by a circular board from which perpendicularly extends a cylindrical peripheral wall extending along a longitudinal axis toward a distal circular edge; and
a non-magnetic tube member fixed to the magnetic cap member, the non-magnetic tube member axially extending between a first edge arranged inside the magnetic cap member, and a second edge, the non-magnetic tube member being adapted to be fixed on the body member in order to magnetically isolate the magnetic cap member from the body member, the non-magnetic tube member being located inside the cylindrical peripheral wall of the magnetic cap member so that the second edge of the non-magnetic tube member is flush with the distal circular edge of the magnetic cap member;
the magnetic plunger member being adapted to axially translate under the influence of a magnetic field within an internal cylindrical volume defined by the cap assembly and the body member.

16. A body assembly as claimed in claim 15 wherein the cap assembly is fixedly arranged on the body member, and an internal face of the non-magnetic tube member being adjusted onto an external face of the body member that is adjacent to the distal second transverse face.

17. A body assembly as claimed in claim 16 wherein the non-magnetic tube member is only partially arranged onto the body member, a portion of the non-magnetic tube member axially extending beyond the second distal transverse face of the body member.

18. A body assembly as claimed in claim 15 wherein a cylindrical portion of the body member adjacent to the second transverse face of the body member merges into an external shoulder face against which is the second edge of the non-magnetic cylindrical tube member.

19. A body assembly as claimed in claim 18 wherein a non-magnetic welding seam joins the body member to the cap assembly

20. A body assembly as claimed in claim 19 wherein the non-magnetic welding seam is arranged between the distal circular edge of the cap member and the external shoulder face of the body member.

21. A pressure regulating valve which regulates the pressure inside a common rail reservoir of fuel injection equipment, the pressure regulating valve comprising:
a magnetic plunger assembly;
a needle valve member;
a body member having a substantially cylindrical form made of a plurality of coaxial cylindrical portions extending along a longitudinal axis between a first transverse face, adapted to be fixed in the common rail reservoir and, a distal second transverse face, which receives the magnetic plunger assembly; the body member being further provided with an axial through bore opening in both the first transverse face and the distal second transverse face and receiving the needle valve member slidably to translate between an open position and a closed position; and
a cap assembly comprising:
a magnetic cap member having a disc face limited by a circular board from which perpendicularly extends a cylindrical peripheral wall extending along the longitudinal axis toward a distal circular edge; and
a non-magnetic tube member fixed to the magnetic cap member, the non-magnetic tube member axially extending between a first edge arranged inside the magnetic cap member, and a second edge, the non-magnetic tube member being fixed on the body member in order to magnetically isolate the magnetic cap member from the body member, the non-magnetic tube member being located inside the cylindrical peripheral wall of the magnetic cap member so that the second edge of the non-magnetic tube member is flush with the distal circular edge of the magnetic cap member.

22. A pressure regulating valve as claimed in claim 21 further comprising a solenoid assembly arranged over the cap assembly, said actuator assembly generating a magnetic field when electrically energized.
